(19) United States
(12) Patent Application Publication
(10) Pub. No.: US 2001/0046559 A1
(43) Pub. Date: Nov. 29, 2001

(54) Friction coating for gripping surfaces

(76) Inventor: Randy Craig Hewitson, Palm Desert, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/776,390

(22) Filed: Feb. 2, 2001

Related U.S. Application Data
(60) Provisional application No. 60/180,018, filed on Feb. 3, 2000.

(51) Int. Cl. B05D 3/02; B05D 5/02

(52) U.S. Cl. 427/256; 427/385.5

(57) ABSTRACT

A friction coating for the gripping surface of drumsticks, guitar picks, hockey sticks, and other handheld equipment. The friction coating is comprised of a friction coating material and a method of application. The friction coating material is a translucent liquid comprising a volatile solvent that evaporates and leaves an unobtrusive coating of self-adhesive polyurethane of high coefficient of friction. In one embodiment the friction coating material includes a silica grit suspended in the liquid friction coating. In one embodiment the friction coating material is supplied in different versions with different sizes of grit suspended in each. The different versions are provided with distinguishing colors to differentiate the different sizes of grit provided therein. The friction coating is painted or daubed onto the gripping surface of a drumstick and allowed to air dry. The friction coating material can be applied by the user or can be applied by the manufacturer.

### RELATED APPLICATIONS

This application claims the benefit of U.S. Provisional application No. 60/180,018 filed Feb. 3, 2000, entitled Friction Coating for Drumsticks.

### BACKGROUND OF THE INVENTION

1. Field of the Invention

The present invention relates to handheld instruments and equipment and, in particular, to a substance and procedure for providing a friction coating for drumsticks, guitar picks, ball bats, and the like.

2. Description of the Related Art

Many live musical performances and studio recording sessions involve the use of drums. Drums provide the tempo for the music and an integral percussive portion of the music. Drummers employ accessories called drumsticks to provide the percussive impact on the drum heads, cymbals, etc. Drumsticks are typically cylindrical, approximately 1 foot in length, and are typically made out of smooth, finished wood. They are generally provided with either shaped wood or nylon tips.

The impact of the drumstick onto the drum head, cymbal, etc. develops the sound that forms the music. Drummers can create a variety of sounds by striking different parts of the drum assembly and with different parts of the drumstick. They hold the drumstick in different manners. Hundreds of different drumsticks are available on the market and drummers typically experiment with different sticks and striking techniques to achieve the desired tonal qualities. Achieving a desired drum sound is a major concern to a professional drummer.

Live performances are typically performed under artificial lighting. This lighting is often of such an intensity as to impart a fair degree of heating to the performers on stage. Drumming itself involves a fair amount of physical movement. Because of these factors, drummers often perspire to such a degree that their hands become damp. The typical wood finish on drumsticks is a smooth varnish. In combination with hands damp from sweat, the drumstick can easily fly out of the drummer's hands particularly when the drummer strikes the drum set with some force.

As a drumstick is a rigid wood object, it can be appreciated that, as a projectile, an errant drumstick could cause injury to the drummer, other performers, or members of the audience. Also, when a drumstick flies out of the drummer's hands, it causes an unexpected and undesirable interruption to the performance. In addition, when a drumstick flies into the audience the drumstick is typically not returned thereby imposing a replacement cost on the drummer.

In order to improve their grip on the drumstick, some drummers have employed gloves. These gloves are similar to gloves used for racquetball or golf to improve grip. However, using these gloves has some disadvantages. The gloves are rather obvious in use. As a live performance is a visual as well as an acoustic experience, many drummers find the obvious wearing of gloves to be a detriment to their performance. Also, the gloves provide a material barrier between the drummer's hands and the drumstick and add at least some additional bulk to the drummer's hands. This dulls their tactile feel for the drumstick itself and impairs their ability to deftly manipulate the drumsticks.

A second method employed to improve grip on the drumstick is to wrap the drumstick with a friction tape, similar to what is done with baseball bats or tennis rackets. The tape however also has several disadvantages. A tape wrap is also somewhat obvious in use and is disfavored for the reasons mentioned above. A tape wrap is also fairly massive, especially in proportion to the overall weight of a drumstick. This significantly affects the weight balance of a drumstick. Also, as mentioned above, the interaction of the drumstick and the drumming surface produces the sounds that make up the music. The combination of the additional weight of the tape, the change to the balance of the drumstick, and changes to the stiffness modulus of the drumstick with the applied tape can significantly and negatively affect the tonal qualities for the drummer.

Drummers can play both indoors and outside and in widely different conditions. One day a drummer may play in mild dry conditions indoors and the next outdoors during a rainstorm. Both the use of gloves and wrapping the drumsticks provide a single coefficient of friction which can be either greater or less than ideal for the playing conditions for the drummer. A drummer that plays in widely different conditions may wish to have some drumsticks with a high coefficient of friction at the gripping surface and some with a lower coefficient of friction. A drummer would want to be able to readily distinguish between drumsticks with different friction characteristics.

Similar concerns are experienced by guitar players. Many guitar players employ a rigid plastic or bone device called a pick to pluck and strum the guitar strings. The pick is approximately 1-2 mm thick and is generally a rounded, equilateral triangle approximately 3 cm across. A pick is smooth and suffers similar gripping concerns as mentioned above for the drumsticks. They tend to get slippery as the player's hands sweat and loosing grip on the pick would interrupt a performance. Picks are not suited to wrapping with tape because of their small size and irregular shape. The small size of a pick also makes the use of gloves problematic.

Sports equipment, such as ball bats and hockey sticks, are others items of common use that are subject to grasping concerns. Sports equipment is often used in varying weather conditions and the user's grasping hands often become wet with sweat developed through the exertion of the game. As mentioned above, people have employed gloves or tape wraps to increase the coefficient of friction to thereby improve their grip of the equipment. However, gloves are an additional piece of equipment that would need to be purchased, brought to the game, and worn to be effective. Tape wraps are time consuming to apply and have a tendency to become loose after extended use.

From the foregoing, it can be appreciated that there is a continuing need for a method of improving the ability of a user to securely grasp slippery objects particularly with damp hands or in wet weather conditions. The method of improving the grip should be unobtrusive in use and not readily apparent to observers. The method of improving grip should not impair the user's feel of the object so equipped. The method should minimally affect the weight balance and stiffness of the object. The method should provide varying amounts of friction increase and the different degrees of friction increase should be readily apparent to the user. The method should be readily useable on different areas of an object so as to allow the user to customize the object for their individual desires. The method should also be readily employed by manufacturers of objects so as to be able to supply pretreated equipment.

### SUMMARY OF THE INVENTION

The aforementioned needs are satisfied by the friction coating for gripping surfaces of the present invention which, in one aspect, comprises a method for increasing the frictional coefficient of a gripping surface. The method comprises a friction coating material and a method of application to the gripping surface.

In one embodiment, the friction coating material is a viscous liquid with a volatile solvent. When exposed to air the friction coating material outgasses the volatile solvent leaving behind a tacky polyurethane. This polyurethane adheres to the surface it is applied to, for example, in one embodiment, a drumstick. The polyurethane has a high coefficient of friction. The friction coating material is, in one embodiment, a translucent material.

Translucent herein should be understood to mean that the material allows light to readily pass through the material. Translucent should also be understood to mean that the material allows the inherent color of any underlying object to be generally apparent and relatively unchanged when the underlying object is covered with a thin layer of the translucent material.

In one embodiment of the present invention, the friction coating also includes a silica grit suspended in the viscous liquid. The silica grit is embedded in the polyurethane after the volatile solvent outgasses. It can be appreciated that the silica grit would also act to improve the friction of the surface to which it is applied.

In another embodiment of the present invention, the friction coating is provided with different sizes of silica grit. Larger grit would provide a more secure gripping surface. The smaller grit would provide a somewhat less secure gripping surface, but still more secure than an uncoated drumstick. The friction coatings would be provided with different colors to enable the user to distinguish between the larger and the smaller grit coating simply by looking at them. An additional color would be used to indicate a coating without grit.

The method for increasing the frictional coefficient of a gripping surface also includes a method for applying the friction coating material described above. In one embodiment of the present invention, the friction coating material is supplied as a liquid in metal containers similar to the cans known in the art to contain PVC cement, for example. These containers include a dauber applicator. In order to apply the coating the user uses the dauber, wetted with the liquid friction coating material, and paints or daubs a thin layer of the material onto the desired location of a clean, dry object. The object can also be dipped into an open container of the liquid friction coating material and withdrawn, thereby coating the gripping surface. The freshly coated object is positioned such that the liquid coating is only in contact with air and allowed to air dry in a well ventilated area.

It will be appreciated that by providing a tacky surface preparation the friction coating for gripping surfaces improves a user's ability to securely grip an object so coated. By comprising a generally translucent material of relatively thin thickness, the friction coating is unobtrusive and is only apparent upon close inspection of the object so coated. Thus, the visual aspect of the use of the object is unaffected by the use of the present invention. Since the friction coating is applied directly, the user grips the coated object directly and is able to maintain a desirable tactile feel. By comprising a relatively thin coating of relatively low mass the friction coating minimally affects the weight balance and stiffness qualities of an object so coated especially compared to a tape wrapping. These and other objects and advantages will become more fully apparent from the following description taken in conjunction with the accompanying drawings.

### BRIEF DESCRIPTION OF THE DRAWINGS

FIG. 1 shows a typical drumstick with the friction coating of the present invention applied;

FIG. 2 illustrates a guitar pick provided with the friction coating;

FIG. 3 shows a hockey stick provided with the friction coating both on the handle and the blade;

FIG. 4 shows a closed container of the friction coating of the preferred embodiment;

FIG. 5A shows an open container of the friction coating of the preferred embodiment; and

FIG. 5B shows a dauber applicator for the friction coating of the preferred embodiment.

### DETAILED DESCRIPTION OF THE PREFERRED EMBODIMENT

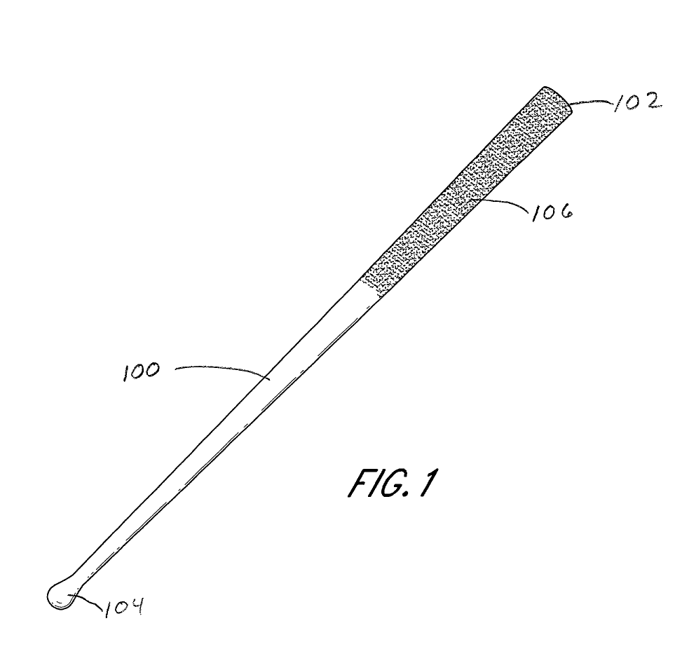

Reference will now be made to the drawings wherein like numerals refer to like parts throughout. Referring to FIG. 1, a drumstick 100 is shown in perspective view.

Drumsticks 100 are elongate members generally constructed of wood. Drumsticks 100 are approximately 1′ in length and between ½″ and ¾″ in thickness. Drumsticks 100 are typically sanded and finished in a manner well known in the art so as to have a smooth surface. Drumsticks 100 are readily available on the market from a variety of sources. Drumsticks 100 are used by drummers to strike various drumming surfaces to create percussive musical sounds.

Drumsticks 100 have a first lateral end 102 and a second lateral end 104 opposite the first lateral end 102. In the preferred embodiment of the present invention, the first lateral end 102 is provided with a thin layer of a friction coating material 106 in a manner that will be described in greater detail below.

The friction coating material 106 is, in one particular embodiment, a viscous liquid comprising toluol. The friction coating material 106 in this embodiment comprises a volatile solvent. The volatile solvent evaporates when the friction coating material 106 is exposed to air. When the volatile solvent is allowed to evaporate, a polyurethane is left that self-adheres to most surfaces. The polyurethane has a high coefficient of friction. Thus, the friction coating material 106 increases the coefficient of friction of surfaces to which the friction coating material 106 is applied. The friction coating material 106 of this embodiment is a translucent material.

In another embodiment of the present invention, a silica grit is suspended in the friction coating material 106. When the volatile solvent is allowed to evaporate, the silica grit is left embedded in the polyurethane. The silica grit is of such a size and nature as to provide a high coefficient of friction when it is held in place by the polyurethane.

In yet another embodiment, a portion of the friction coating material 106, comprising toluol, is evaporated in a known manner so as to create a solid, particulate residue. The residue is of such composition as to provide a gritty, granular substance. The residue is also of such composition that the solid residue will not redissolve when added back to a portion of the liquid friction coating material 106. Thus, in this embodiment, the added step of drying a portion of the friction coating material 106 creates a insoluable grit that can be added to liquid friction material 106. This embodiment has the advantage that the dried friction coating material 106 is of comparable density to the liquid friction coating material 106 and thus, when dried friction coating material 106 is added to liquid friction coating material 106, the dried material 106 tends to remain in suspension and minimally settles out of the liquid material 106. This facilitates applying the friction coating material 106 in a uniform manner with minimal variations in the amount of dried material 106 entrained in any given portion of liquid material 106 provided with the dried material 106.

In one aspect of the present invention, the friction coating material 106 is provided in different versions with different sizes of silica grit. The different versions of the friction coating material 106 are provided with a recognizable color to distinguish the different size of grit suspended in each version of the friction coating material 106. A translucent version of friction coating material 106 has no grit suspended in it. A first colored version of friction coating material 106 has a relatively small size of grit suspended in it, while a second colored version of the friction coating material 106 has a larger size of grit suspended in it. The different versions of friction coating material 106 retain their distinguishing color after the volatile solvent evaporates and allow the user to readily determine whether the drumstick 100 is coated with friction coating material 106 without grit, with small grit, or with large grit.

The friction coating material 106 of this embodiment is available from American Guardian Protection Incorporated of Beaver Falls, Pennsylvania under the product name Truck Bed Liner.

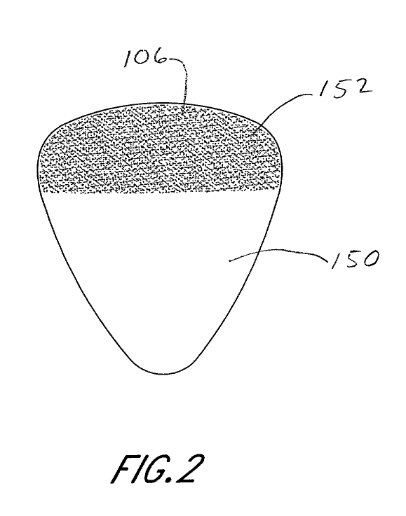

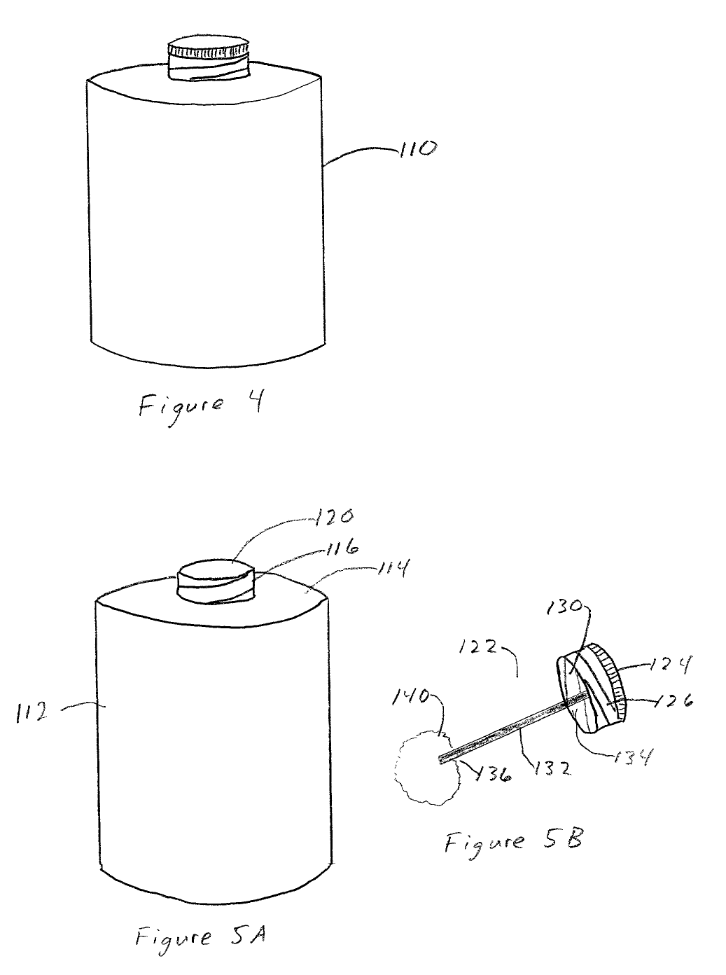

FIG. 2 is a perspective view of a guitar pick 150. The guitar pick 150 is a rounded equilateral triangle shaped piece of semi-rigid material, such as plastic or bone, approximately 3 cm on a side and 1-2 m thick. The guitar pick 150 is employed by guitar players to perturb guitar strings so as to produce musical sounds in a known manner. The guitar pick 150 comprises a gripping surface 152 adjacent one side of the guitar pick 150. The gripping surface 152 provides a surface for a guitar player to grip the guitar pick 150. The gripping surface 152 of the guitar pick 150 is provided with friction coating material 106 substantially similar to the friction coating material 106 previously described in a manner that will be described in greater detail below with reference to FIGS. 5A and 5B.

FIG. 3 is a perspective view of a hockey stick 160. The hockey stick 160 is an elongate member of semi-rigid material, such as wood, and is used in the game of hockey in a known manner. The hockey stick 160 has a gripping surface 162 adjacent a first end of the hockey stick 160 and a striking surface 164 adjacent an opposing second end of the hockey stick 160. The gripping surface 162 and the striking surface 164 are provided with friction coating material 106 in a manner that will be described in greater detail below.

The friction coating material 106 increases the coefficient of friction of the gripping surface 162 to improve a user's grasp of the hockey stick 160. The friction coating material 106 also improves the contact between the striking surface 164 and a hockey puck. It is envisioned that, in one embodiment of the invention, a user will provide different versions of the friction coating material 106 to the gripping surface 162 and the striking surface 164 to achieve different coefficients of friction.

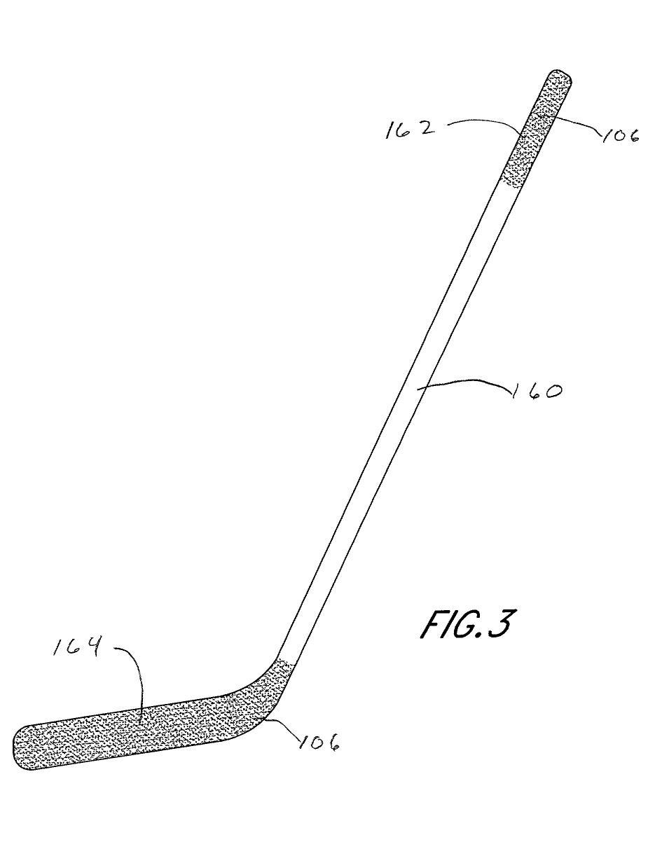

Referring to FIG. 4, a container 110 of the friction coating material 106 is shown in an assembled condition in perspective view. The container 110 is generally cylindrical and is made of plated metal in a manner well known in the art. The container is approximately 3″ in diameter and approximately 4″ in height. The container 110 holds approximately 8 fluid ounces of the friction coating material 106.

Referring to FIGS. 5A and 5B, the container 110 of FIG. 4 is shown in an unassembled state. The container 110 of FIG. 4 comprises a can 112. The can 112 is generally a closed, right-cylinder and is made of plated metal in a manner well known in the art. The can 112 is approximately 3″ in diameter and approximately 4″ in height. The can 112 holds approximately 8 fluid ounces of the friction coating material 106. The can 112 is provided with a top end 114. The top end 114 is circular and encompasses the diameter of the can 112. The center of the top end 114, and thereby the can 112, is provided with an attachment provision 116.

The attachment provision 116 is an open cylinder, approximately 1″ in diameter. The attachment provision 116 extends approximately ¾″ in height from the surface of the top end 114. The attachment provision 116 is materially part of and made of the same plated metal as the can 112. The attachment provision 116 is externally threaded and serves as an attachment surface for an applicator assembly to be described in greater detail below. The attachment provision 116 also provides a circular opening 120 that provides access through the attachment provision 116 and into the interior of the can 112.

The container 110 also comprises an applicator assembly 122. The applicator assembly 122 is assembled from several component pieces that will be described in greater detail below. The applicator assembly 122 serves as an applicator for the friction coating material 106 in a manner that will be described in greater detail below.

The applicator assembly 122 comprises a lid 124. The lid 124 is cylindrical and is open on one end and closed on the opposite end. The lid 124 is made of plated metal similar to that which makes up the can 112. The lid 124 has an outer surface 126 and an inner surface 130. The lid 124 is internally threaded so as to mate with the external threads on the attachment provision 116, thereby allowing the lid 124 to attach to the attachment provision 116 with a screw motion. Thus, the lid 124 can enclose the can 112 to thereby limit spillage of the friction coating material 106 and evaporation of the volatile solvent of the friction coating material 106. The outer surface 126 of the lid 124 is serrated and serves as a gripping surface for the lid 124 and thereby the applicator assembly 122.

The applicator assembly 122 also comprises an applicator shaft 132. The applicator shaft 132 is a rigid, elongate member approximately 3″ in length. The applicator shaft has a first lateral end 134 and a second lateral end 136 opposite the first lateral end 134. The first lateral end 134 of the applicator shaft 132 is affixed to the center of the inner surface 130 of the lid 124 in a manner well known in the art. The applicator shaft 132 interconnects and locates the lid 124 with a dauber 140.

The dauber 140 is generally spherical in shape and is made from a fibrous, absorbent material. The dauber 140 is made of a material such that the dauber 140 is not soluble in the volatile solvent of the friction coating material 106. The dauber 140 is affixed to the second lateral end 136 of the applicator shaft 132 in a manner well known in the art.

In one embodiment, the dauber 140 takes up friction coating material 106 from the interior of the can 112 and deposits the friction coating material 106 in the following manner. The outer surface 126 of the lid 124 of the applicator assembly 122 is grasped and the dauber 140 of the applicator assembly 122 is placed through the opening 120 of the attachment provision 116 and thus into the interior of the can 112. The dauber 140 is allowed to absorb some friction coating material 106, then the dauber 140 is withdrawn from the can 112. The applicator assembly 122, and thereby the dauber 140, is manipulated so as to bring the dauber 140 into contact with the desired area of the object, such as a drumstick 100, guitar pick 150, or hockey stick 160. The applicator assembly 122, and thereby the dauber 140, is swept over the region that the user wishes to be coated with the friction coating material 106 such that the dauber 140 stays in contact with the object. The dauber 140 and the friction coating material 106 are of such a nature that the friction coating material 106 will transfer from the dauber 140 to the surface of the object in a manner well known in the art.

The dauber 140 can be reinserted into the can 112 in order to retrieve and apply more of the friction coating material 106, however the friction coating material 106 is of such a nature that a thin layer of the material 106 will achieve the desired effect of increasing the coefficient of friction. When the friction coating material 106 is sufficiently applied to the object, the object is placed and held in such a position that the friction coating material 106 is held away from contact with other objects or materials and is exposed to a well ventilated air supply. The coated object is allowed to air dry for a period of time so as to allow the volatile solvent component of the friction coating material 106 to evaporate and leave the polyurethane behind.

In another embodiment of the present invention, the friction coating material 106 is applied to an object, such as the drumstick 100, guitar pick 150, or hockey stick 160, in the following manner. The first lateral end 102 of the object is placed into an open can 112 that is filled with friction coating material 106 to the depth that the user wishes to coat the object. The object is then withdrawn from the can 112 and the object is placed and held in such a position that the friction coating material 106 is held away from contact with other objects or materials and is exposed to a well ventilated air supply. The coated object is allowed to air dry for a period of time so as to allow the volatile solvent component of the friction coating material 106 to evaporate and leave the polyurethane behind.

The friction coating material 106 leaves behind a polyurethane after the volatile solvent evaporates. The polyurethane has a high coefficient of friction and the friction coating material 106 self-adheres to surfaces. Thus, the friction coating material 106 improves the ability of a user to grasp an object coated with the friction coating material 106. In one embodiment of the present invention, a silica grit is suspended in the friction coating material 106 such that the silica grit is imbedded in the polyurethane after the volatile solvent evaporates. The silica grit also has a high coefficient of friction and, since it is held in place by the polyurethane, the silica grit also improves the ability of a user to grasp an object coated with the friction coating material 106.

The friction coating material 106 is generally translucent in this embodiment. The friction coating material 106 and method of application are of such a nature that only a thin layer is needed to achieve the purpose of improving the ability of a user to grasp an object. Thus, the friction coating material 106 is unobtrusive and not readily apparent to observers.

The friction coating material 106 is applied directly to an object. Only a thin layer of the friction coating material need be used thus allowing the user to maintain a good feel of the object. It will be appreciated that the user can apply the friction coating material 106 at any location where the user will grasp an object without departing from the spirit of the present invention.

The polyurethane that adheres to the object after the volatile solvent evaporates from the friction coating material 106 is low in mass. The polyurethane of the friction coating material 106 is an elastic substance. A small amount of elastic material that covers a rigid body, such as a drumstick 100, minimally changes the stiffness modulus of the rigid body. Thus, the friction coating material 106 and manner of application described herein will minimally affect the overall weight, the weight balance, and the stiffness modulus of a drumstick 100 so coated. Thus the weight balance and tonal qualities of a drumstick 100 coated with the friction coating material 106 of the present invention will be minimally affected.

The friction coating material 106 can be applied by the user in a variety of places and manners as described above. Thus it can be seen that the friction coating material 106 and method of application described herein allow for user customization. The friction coating material 106 and method of application described herein can readily be adapted by those skilled in the art to a manufacturing environment. Thus, the friction coating material 106 can be readily used by a manufacturer to provide pre-coated objects.

Although the foregoing description of the preferred embodiment of the present invention has shown, described, and pointed out the fundamental novel features of the invention, it will be understood that various omissions, substitutions, and changes in the form of the detail of the apparatus as illustrated as well as the uses thereof, may be made by those skilled in the art without departing from the spirit of the present invention. Consequently, the scope of the present invention should not be limited to the foregoing discussions, but should be defined by the appended claims.

What is claimed is:

1. A method of increasing the frictional coefficient of a gripping surface, the method comprising:
coating the gripping surface with a liquid material; and
drying the liquid material such that the frictional coefficient of the gripping surface is increased and so that the resulting coating is translucent thereby allowing the gripping surface to be visible through the coating.

2. The method of claim 1, wherein the gripping surface comprises a first lateral end of a drumstick.

3. The method of claim 1, wherein the gripping surface comprises a first side of a guitar pick.

4. The method of claim 1, wherein coating the gripping surface comprises coating the gripping surface with a liquid containing a polyurethane and a solvent.

5. The method of claim 4, wherein drying the liquid material comprises evaporating the solvent such that a coating containing polyurethane adheres to the gripping surface.

6. The method of claim 1, wherein coating the gripping surface comprises coating the gripping surface with a liquid containing a grit material such that, upon drying, the grit material is encapsulated in the coating such that the grit increases the coefficient of friction of the gripping surface.

7. The method of claim 6, wherein coating the gripping surfaces comprises coating the gripping surface with a liquid containing a grit material comprised of a plurality of silica particles suspended in the liquid.

8. The method of claim 1, wherein the liquid material is comprised of a solvent component and a solid grit component wherein the solid grit component is obtained from the liquid material and added to the liquid material wherein the solid grit component is insoluble in the solvent component and wherein the solid grit component remains upon evaporation of the solvent component.

9. The method of claim 8, wherein the solid grit component is neutrally buoyant in the liquid material.

10. The method of claim 8, wherein the liquid material comprises toluol.

11. The method of claim 1, further comprising providing a container in which the liquid material is stored prior to application.

12. The method of claim 11, wherein providing a container comprises providing a container having an applicator attached to the lid of the container to thereby allow individual users to purchase the container and individually apply the liquid.

13. The method of claim 12, wherein providing the container comprises providing a container having approximately 8 ounces of the liquid contained therein.

14. A method of increasing the frictional coefficient of a gripping surface, the method comprising:
coating the gripping surface with a liquid material; and
drying the liquid material such that the resulting coating residue comprises an elastomeric polyurethane solid.

15. The method of claim 14, wherein the liquid material dries to a translucent polyurethane coating.

16. A method for providing differing increases in the coefficient of friction of a gripping surface, the method comprising:
coating the gripping surface with a first liquid material; and
drying the first liquid material such that the coefficient of friction of the gripping surface is increased a first amount.

17. The method of claim 16 wherein the first liquid material is of a first distinguishing color.

18. The method of claim 17 wherein the first liquid material of the first distinguishing color contains a first size of grit material such that upon drying the grit material is encapsulated in the coating such that the grit material increases the coefficient of friction of the gripping surface a first amount.
